(19) United States
(12) Patent Application Publication
(10) Pub. No.: US 2011/0001314 A1
(43) Pub. Date: Jan. 6, 2011

(54) SECURITY CODES WITHIN SCRATCH-OFF LAYERS AND METHOD OF EMBEDDING THEREOF

(75) Inventors: Reiner Eschbach, Webster, NY (US); David A. Mantell, Rochester, NY (US)

Correspondence Address: PEPPER HAMILTON LLP, 500 GRANT STREET, ONE MELLON CENTER, 50TH FLOOR, PITTSBURGH, PA, 15219, US

(73) Assignee: Xerox Corporation, Norwalk, CT (US)

(21) Appl. No.: 12/496,208

(22) Filed: Jul. 1, 2009

(51) Int. Cl. B42D 15/00

(52) U.S. Cl. 283/85

(57) ABSTRACT

A scratch-off document may include a substrate bearing printed content and a scratch-off layer covering the printed content. The scratch-off layer may include a mass of a first ink and a portion of a second ink embedded within the first ink. The first ink and the second ink may exhibit a metameric match when exposed to visible light, and the second ink may be positioned to form a security code

### BACKGROUND

1. Technical Field

This application relates to printing scratch-off documents. More specifically, the present disclosure relates to a scratch-off document and method of printing an embedded security code within the scratch-off layer of a document for printing applications such as instant lottery tickets.

2. Description of Related Prior Art

Many different applications use scratch-off type documents. One of many such applications involves instant lottery tickets. These tickets, for instance, typically contain printed data on a substrate which is covered by a scratch-off material to hide the printed data. The scratch-off material may be removed by rubbing it with a hard object, such as a coin or fingernail, to reveal the underlying printed data. The scratch-off material, however, must sufficiently adhere to the substrate so that ordinary handling will not remove the scratch-off material.

Producing scratch-off documents involves complex printing applications which require high volume, low cost printing and other areas of variable data such as winning indicia, number marking and bar code generation. Also adding to the complexity of manufacturing scratch-off tickets is the need to protect winning tickets from detection. Examples of detection include the ability to read the winning ticket prior to purchase. For instance, infrared detection may serve to identify, or read, winning tickets. Another method of detecting a winning ticket includes scratching off the scratch-off material to find the winning ticket and then recoating the material onto the ticket. Unscrupulous individuals may then knowingly sell losing tickets. Such methods of detection are also possible for other value documentation readings having content to be protected, such as bank mailings containing PIN codes.

One standard process of hiding ticket information to protect from this form of detection involves using multi-layer approaches with multi-layer coatings and overprints, often using repeating and alternating layers of material being deposited. Such a process is expensive and not desirable for low value applications. Techniques have been developed in attempt to create scratch-off documents and also improvements have been described to prevent the infrared detection approach, including modifying the data encoding so that the winning information is printed without an infrared signature, as disclosed by U.S. Application Pub. No. 2008/0131176, U.S. Application Pub. No. 2007/0281224, and U.S. application Ser. No. 12/104,533, all incorporated herein by reference. Another technique involves providing false information that an infrared detection will read, as disclosed by U.S. application Ser. No. 11/758,388, incorporated herein by reference. These techniques, however, do not prevent detection via the scratch-off and re-coat detection technique.

### SUMMARY

Before the present systems, devices and methods are described, it is to be understood that this disclosure is not limited to the particular systems, devices and methods described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Thus, for example, reference to a “substrate” is a reference to one or more substrates and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention. As used herein, the term “comprising” means “including, but not limited to.”

In an embodiment, a scratch-off document may include a substrate bearing printed content and a scratch-off layer covering the printed content. The scratch-off layer may include a mass of a first ink and a portion of a second ink embedded within the first ink. The first ink and the second ink may exhibit a metameric match when exposed to visible light, and the second ink may be positioned to form a security code.

In an alternative embodiment, a method of embedding a security code into a scratch-off document may include printing a first layer of a first ink, printing a layer of a second ink onto the first layer of the first ink, and printing a second layer of the first ink over the second ink so that it covers one or more portions of the second ink. The first ink may include a portion of a scratch-off layer. The second ink may include a security code and a second portion of a scratch-off layer, and the first ink and the second ink may exhibit a metameric match when exposed to visible light.

Optionally, in the method above, the first and second inks may be initially applied to an intermediate surface and the first and second inks may be adhered to a substrate through a transfer from the intermediate surface to the substrate. Alternatively, a substrate may bear printed material, and printing onto the substrate the first layer of the first ink and the second layer of the first ink may include printing the first ink to cover the printed material.

### BRIEF DESCRIPTION OF THE DRAWINGS

Aspects, features, benefits and advantages of the present application will be apparent with regard to the following description and accompanying drawings, of which:

FIG. 1 illustrates an exemplary scratch-off document according to an embodiment.

FIGS. 2A-2C depict flow diagrams of exemplary methods of embedding a security code into a scratch-off document according to various embodiments.

### DETAILED DESCRIPTION

For the purposes of the discussion below, a “substrate” refers to a document or other material. A substrate may refer to a sheet of paper and/or the like.

For the purposes of the discussion below, “ink” refers to the wet or dry material that forms an image or text on a substrate. The terms ink and toner are used interchangeably to refer to this material. A solid ink or a phase-change ink is an ink that is a solid at room temperature. Solid inks typically are heated to a molten state and are printed with an ink jet device. A layer of ink may refer to a single ink or a combination of different color inks combined to create a color or pattern. A layer of ink may refer to a combination of different color inks arranged as a mixture of the colors, layers of the colors, or a combination of the two. The ink may be printed directly on the substrate or alternatively ink may be printed on an intermediate surface and then subsequently transferred to the substrate.

For the purposes of the discussion below, “metameric match” is an approximate visual match dependent on an illuminant, such as daylight and/or cool white fluorescent. A match may be a comparison of objects apparently similar in optical response to a casual human observer given reasonably precise and accurate measurement conditions. An approximate metameric match, or visual response, in normal light conditions may be represented by the following well known description, wherein the eye integrates over several wavelengths: the visual response is equal to the product of a light source multiplied by a color of an object multiplied by a sensitivity of the eye. Being a definite integral, over the visible wavelengths, it is self-evident that many integrands will yield the same result. These different integrands are different illuminant and/or object products. One can consequently calculate the quality of the match as, for example, the deviation of the two definite integrals from each other. The result may be a color difference preferably expressed in a visually relevant space with the difference being named ΔE. A perfect metameric match would thus have a ΔE of 0, which is rarely if ever achieved. A ΔE of 1 represents the smallest color difference that a human eye can see. However, even this is not necessary in the majority of applications. As many other factors such as overall light-level and spatial extent influence visibility, a ΔE of 10 or even more might often be a sufficient metameric match in real world scenarios.

Use of the phrase “exposed to” inherently includes the ability to detect an exposure. For a detection in the visible spectrum, the human visual system may be sufficient. For areas outside the visible spectrum, a proper detection apparatus may be assumed.

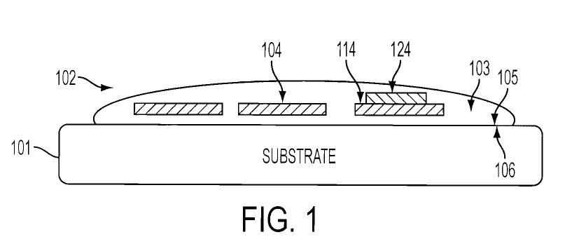

FIG. 1 depicts illustrates an exemplary scratch-off document according to an embodiment. As shown in FIG. 1, a scratch-off document may include a substrate 101 bearing printed content. In an embodiment, the ink used to place printed content on the substrate 101 may be a permanent, xerographic ink and/or the like. The scratch-off document may also include a scratch-off layer 102, which may cover the printed content. The scratch-off layer 102 may include a mass of a first ink 103 and a portion of a second ink 104 embedded within the first ink 103. In an embodiment, the first ink 103 and the second ink 104 may be solid ink. In an embodiment, the portion of the second ink 104 may be embedded in the mass of the first ink 103 so that a first portion of the first ink 103 covers the second ink 104. Further, a second portion of the first ink 103 may be positioned between the second ink 104 and the substrate 101 so that the second ink 104 does not contact the substrate 101. In another embodiment, some portion of the first and second inks may be intermixed. In the various embodiments, the first ink 103 and the second ink 104 may exhibit a metameric match when exposed to visible light. The second ink 104 may be positioned to form a security code. In further embodiments, the first ink 103 and the second ink 104 or portions thereof may not exhibit a metameric match when exposed to visible light and a message or security code may be visible to a human observer. In an embodiment, the first ink 103 may cover the second ink and include an ink that does not display a detectable security code when exposed to non-visible light. Additionally, the second ink 104 may include an active ink that displays the security code when exposed to non-visible light.

In an embodiment, the first ink 103 may include a thick, removable ink that does not display a detectable security code when exposed to non-visible light. Alternatively, the first ink 103 may include a solid ink that does not display a detectable security code when exposed to non-visible light. The solid ink may be a phase-change ink and/or the like. Phase-change ink may initially be a solid, waxy block that is melted and sent to an ink-jet printhead. The phase-change ink may then solidify once it becomes an image on a substrate. Additionally, the second ink 104 may include an active ink that displays the security code when exposed to non-visible light. In an embodiment, the second ink 104 may be a solid ink.

The second ink 104 may further include a separation area 105 with holes where at least a portion of the first ink 103 or the second ink 104 passes through and adheres directly to the substrate 101 at a separation area 105 and at one or more areas of adhesion to form a pattern at the one or more areas of adhesion. In an embodiment, the first ink 103 may adhere to a substrate 101 and be removable from a xerographic, permanent ink. Additionally, the separation area may be an integral part of the xerographic, permanent ink. In an embodiment, the separation area 105 with holes may contain printed content composed of a permanent ink that will not scratch off. The holes may be arranged in a pattern so that when an attempt to scratch off the permanent ink is made, the permanent ink will remain positioned in the form of the pattern, and portions of the second ink will also remain in a pattern that may be detected. The scratch-off layer may include the embodiments described above when the second ink 104 is exposed to an illuminant such as non-visible light, infrared light, fluorescent light and/or the like.

In an embodiment, the first ink 103 may include a thick, removable ink that does not display an infrared detectable security when exposed to infrared light. In another embodiment, the first ink 103 may include a solid ink that does not display an infrared detectable security when exposed to infrared light. The solid ink may be a phase-change ink and/or the like. Phase-change ink may initially be a solid, waxy block that is melted and sent to an ink-jet printhead. Alternatively, the phase-change ink may be a gel ink. The phase-change ink may then cease to be in a liquid state once it becomes an image on a substrate and may be further solidified by the additional of additional energy such as in the form of ultra-violet light.

The second ink 104 may include an infrared active ink 114 that displays the security code when exposed to infrared light. In an embodiment, the second ink 104 may be a solid ink. A common sensor suitably sensitive to the corresponding infrared wavelengths may be used to detect the security code. The infrared active ink may include a dye based ink. Alternately, the infrared active ink may include a carbon black ink. Additional and/or alternate types of infrared active ink may also be used within the scope of this disclosure. In some embodiments, the second ink 104 may include a layer of infrared passive ink 124 positioned to partially obscure the security code that is included in the infrared active portion 114. In an embodiment, the second ink 104 may include an infrared passive portion 124, and an infrared active portion 114 printed over part of the infrared passive portion 124.

In an embodiment, the first ink 103 may include a thick, removable ink that does not display a fluorescence detectable security code when exposed to fluorescent light. In an embodiment, the first ink 103 may include a solid ink that does not display a fluorescence detectable security code when exposed to fluorescent light. The solid ink may be a phase-change ink and/or the like. Phase-change ink may initially be a solid, waxy block that is melted and sent to an ink-jet printhead. Alternatively, the phase-change ink may be a gel ink. The phase-change ink may then cease to be in a liquid state once it becomes an image on a substrate and may be further solidified by the addition of additional energy such as in the form of ultra-violet light. In another embodiment, the second ink 104 may include a fluorescence active ink that displays the security code when exposed to fluorescent light. In an embodiment, the second ink 104 may be a solid ink.

In an embodiment, the first ink 103 may exhibit a first fluorescent signature, and the second ink 104 may exhibit a second fluorescent signature, so that when exposed to fluorescent light the security code is displayed. Alternatively, the security code may include a first ink 103 including a first cyan-magenta-yellow-black (“cmyk”) metamer and a second ink 104 including a second cmyk metamer which displays the security code when exposed to fluorescent light. Additional and/or alternate types of ink may also be used within the scope of this disclosure.

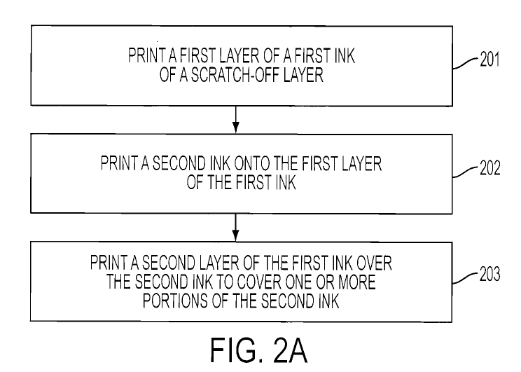

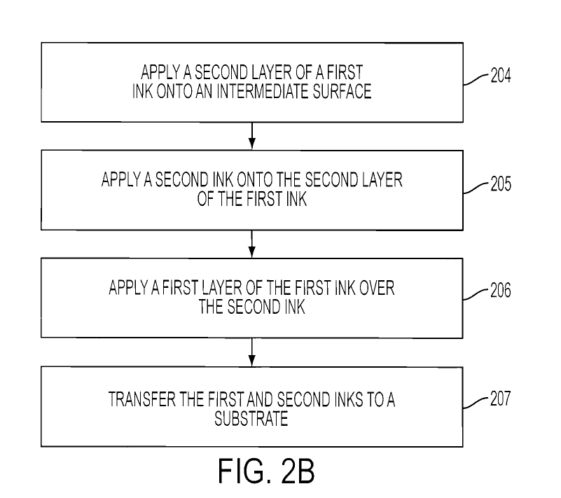

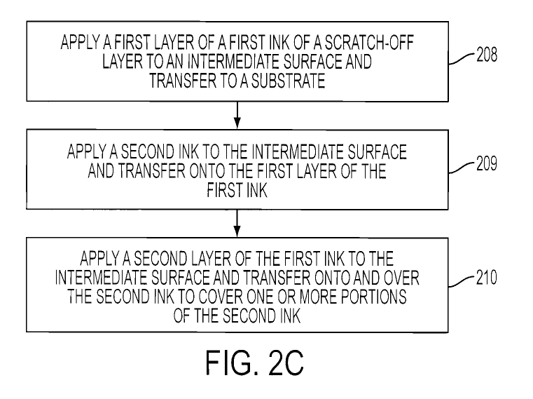

FIGS. 2A-2C depict flow diagrams of exemplary methods of embedding a security code into a scratch-off document according to various embodiments. As depicted in FIG. 2A, a first layer of a first ink may be printed 201. In an embodiment, a first layer of a first ink may be printed 201 onto part of a substrate. In another embodiment, as depicted in FIG. 2C, the first ink may be applied 208 to an intermediate surface, such as a spinning drum of the type used in offset printing and subsequently transferred 208 from the intermediate surface to a substrate. The first ink may include a portion of a scratch-off layer. Optionally, printing the first ink may include printing a separation area where the first ink is removed from the substrate and an adhesion area.

Referring back to FIG. 2A, a layer of a second ink may be printed 202 onto the first layer of the first ink. The second ink may include a security code and/or a second portion of the scratch-off layer. The first ink and the second ink may exhibit a metameric match when exposed to visible light. The second ink may be printed in multiple parts, including an infrared-active portion, with an infrared-passive portion printed over a part of the infrared-active portion. Optionally, the second ink may be applied to the intermediate surface before it is transferred to the substrate. If so, and as depicted in FIG. 2B, a second layer of a first ink may be applied 204 onto an intermediate surface. Additionally, the second ink may be applied 205 to the intermediate surface before the first layer of the first ink is applied 206, so that the second ink is printed over the first layer of the first ink onto the substrate when the first and second inks are transferred 207 to a substrate.

A second layer of the first ink may be printed 203 over the second ink so that it covers one or more portions of the second ink. In an embodiment, the first and second inks may be initially applied onto an intermediate surface, such as a spinning drum of the type used in offset printing systems. In an offset printing process, an inkjet printhead may apply via spray-painting an image onto a spinning drum. The image may then be transferred, or offset, from the drum to a substrate such as paper. The first and second inks may subsequently be transferred from the intermediate surface to a substrate. The method may include adhering the first and second inks to the substrate in a step which transfers the first and second inks from the intermediate surface to the substrate. This adhesion may occur through the adhesion area 106 while the separation area 105 separates the scratch-off layer and the substrate. In an embodiment, and as depicted in FIG. 2C, the second ink may be applied 209 to the intermediate surface and transferred onto the first layer of the first ink, which may have previously been applied 208 to the intermediate surface and transferred to the substrate. A second layer of the first ink may be applied 210 to the intermediate surface and transferred onto and over the second ink to cover one or more portions of the second ink.

In an embodiment, the substrate may bear printed material. Printing the first layer of the first ink and the second layer of the first ink may include printing the first ink to cover the printed material. In an embodiment, printing the layer of the second ink may include printing an infrared active ink in a pattern corresponding to the security code. Additionally, printing the layer of the second ink may include printing an infrared passive ink over a portion of the infrared active ink to cover a portion of the security code.

In an embodiment, the first ink may include an infrared passive area not detectable under infrared light. In an embodiment, the second ink may include an infrared active area detectable under infrared light. A second ink including a dye based ink may be printed 203 onto one or more portions of the first ink. Alternatively, a second ink including a carbon black ink may be printed 203 onto one or more portions of the first ink. Additional and/or alternate types of ink may also be used within the scope of this disclosure.

In an embodiment, the second ink may include a fluorescent active area detectable under fluorescent light. In an embodiment, the first ink may include a fluorescent passive area not detectable under fluorescent light. In an embodiment, the separation area 105 may include holes so that at least a portion of the first layer of the first ink adheres directly to the substrate. In another embodiment, the second portion of the scratch-off layer may include holes so that at least a portion of the first ink or the second ink adheres directly to a substrate.

In an embodiment, printing 202 the layer of the second ink may include printing a fluorescent active ink in a pattern corresponding to the security code. Additionally, printing 202 the layer of the second ink may include printing an ink with a different fluorescent signature over a portion of the fluorescent active ink to cover a portion of the security code, so that when exposed to fluorescent light the security code may be displayed. In an embodiment, the first ink may be composed of multiple component inks that may combine to form a metameric match to the second ink when exposed to visible light.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A scratch-off document comprising:
a substrate bearing printed content; and
a scratch-off layer covering the printed content, the scratch-off layer comprising:
a mass of a first ink and a portion of a second ink embedded within the first ink,
wherein the first ink and the second ink exhibit a metameric match when exposed to visible light, and
wherein the second ink is positioned to form a security code.

2. The scratch-off document of claim 1, wherein:
the first ink covers the second ink and comprises an ink that, when exposed to non-visible light, does not display a detectable security code; and
the second ink comprises an active ink, that, when exposed to non-visible light, displays the security code.

3. The scratch-off document of claim 1, the second ink further comprising:
a separation area with holes, wherein at least a portion of the first ink or the second ink is positioned over the holes so that the portion adheres directly to the substrate at one or more areas of adhesion to form a pattern at the one or more areas of adhesion.

4. The scratch-off document of claim 1, wherein:
the first ink comprises an ink that, when exposed to infrared light, does not display a infrared detectable security code; and
the second ink comprises an infrared active ink, that, when exposed to infrared light, displays the security code.

5. The scratch-off document of claim 4, wherein the infrared active ink comprises a dye based ink.

6. The scratch-off document of claim 4, wherein the infrared active ink comprises a carbon black ink.

7. The scratch-off document of claim 1, wherein:
the first ink comprises an ink that, when exposed to fluorescent light, does not display a fluorescence detectable security code; and
the second ink comprises an fluorescence active ink, that, when exposed to fluorescent light, displays the security code.

8. The scratch-off document of claim 1:
wherein the first ink exhibits a first fluorescent signature; and
wherein the second ink exhibits a second fluorescent signature, so that when exposed to fluorescent light the security code is displayed.

9. The scratch-off document of claim 1, wherein:
the first ink comprises a first cmyk metamer; and
the second ink comprises a second cmyk metamer so that when exposed to fluorescent light the security code is displayed.

10. The scratch-off document of claim 1, wherein a first portion of the first ink covers the second ink, and a second portion the first ink is positioned between the second ink and the substrate, so that the second ink does not contact the substrate.

11. The scratch-off document of claim 1, wherein the second ink comprises an infrared passive portion, and an infrared active portion printed over part of the infrared passive portion.

12. A method of embedding a security code into a scratch-off document, the method comprising:
printing a first layer of a first ink, wherein the first ink comprises a portion of a scratch-off layer;
printing a layer of a second ink onto the first layer of the first ink, wherein the second ink comprises a security code and a second portion of a scratch-off layer, and the first ink and the second ink exhibit a metameric match when exposed to visible light; and
printing a second layer of the first ink over the second ink so that it covers one or more portions of the second ink.

13. The method of claim 12, wherein the first and second inks are initially applied to an intermediate surface and the first and second inks are adhered to a substrate through a transfer from the intermediate surface to the substrate.

14. The method of claim 12, wherein a substrate bears printed material, and printing onto the substrate the first layer of the first ink and the second layer of the first ink comprises printing the first ink to cover the printed material.

15. The method of claim 12, wherein printing the layer of second ink comprises:
printing an infrared active ink in a pattern corresponding to the security code; and
printing an infrared passive ink over a portion of the infrared active ink to cover a portion of the security code.

16. The method of claim 12, wherein the second portion of the scratch-off layer comprises a plurality of holes so that at least a portion of the first layer of the first ink adheres directly to a substrate.

17. The method of claim 12, wherein printing the layer of second ink comprises:
printing a fluorescent active ink in a pattern corresponding to the security code; and
printing an ink with a different fluorescent signature over a portion of the fluorescent active ink to cover a portion of the security code, so that when exposed to fluorescent light the security code is displayed.

18. The method of claim 12, wherein the first ink is composed of multiple component inks that combine to form a metameric match to the second ink when exposed to visible light.
